(19) United States
(12) Patent Application Publication
(10) Pub. No.: US 2008/0214380 A1
(43) Pub. Date: Sep. 4, 2008

(54) Glass Substrate with Low Infrared Transmission for Display Screen

(75) Inventors: Sylvie Abensour, Montlignon (FR); Sung-Min kwon, Neuilly Sur Seine (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN GLASS FRANCE, COURBEVOIE (FR)

(21) Appl. No.: 11/917,011

(22) PCT Filed: Jun. 9, 2006
(86) PCT No.: PCT/FR06/50539

§ 371 Date: May 15, 2008

(30) Foreign Application Priority Data
Jun. 11, 2005 (FR) 05515757

(51) Int. Cl. C03C 3/087; C03C 3/12

(52) U.S. Cl. 501/41; 501/70; 501/71

(57) ABSTRACT

The invention relates to the field of display panels, especially field-emission display panels.

The subject of the invention is a glass composition intended for the manufacture of a substrate for a display panel, having an infrared radiation transmission factor measured at 910 nm (T_{IR910}) of 40% or less, an overall light transmission factor under illuminant D₆₅ (TL_{D65}) of greater than 40%, a dominant wavelength (λ_{D}) that varies from 480 to 570 nm and a purity of 8% or less, these values being measured with a glass thickness of 2.8 mm, said composition comprising the following coloring agents, in percentages by weight:

| | |
|---|---|
| Fe₂O₃ | 0.4-2% |
| FeO | 0.1-0.6% |
| CoO | 0-200 ppm |
| Se | 0-30 ppm |
| NiO | 0-1000 ppm |
| CuO | 0-6600 ppm. |

The invention relates to the field of display panels and more particularly to a substrate made of glass having a low infrared transmission intended to form the front face of field-emission display panels.

Although not limited to such applications, the invention will be more particularly described with regard to substrates used for displaying an image using a display panel of the field-emission type, such as a plasma display panel.

A plasma display panel is generally made up of two glass plates, more commonly called “substrates”, that are separated by a space in which a mixture of plasma gases (Ne, Xe, Ar) is trapped. The internal face of the rear substrate is provided with phosphors that are excited by the ultraviolet radiation emitted by the plasma gas mixture undergoing plasma discharge between the two substrates and generate visible light radiation (red, green, blue). The image produced from this radiation is projected through the substrate forming the front face of the display panel.

The emission of light is also accompanied by infrared radiation between 800 and 1250 nm which passes through the front substrate of the display panel. Now, this radiation is likely to disturb, to a varying extent, the operation of neighboring equipment controlled by infrared, for example by means of remote controls.

Moreover, like all electrical equipment, plasma display panels have addressing systems (called “drivers”) that generate electromagnetic waves liable to interfere with devices such as microcomputers, mobile telephones, etc. To overcome the drawbacks associated with the propagation of the aforementioned undesirable radiation, it is usual to apply, against the front substrate of the display panel, a structure that is both transparent, in order to allow the image to be seen, and metalized in order to provide electromagnetic shielding.

Such a known structure consists of two sheets of a plastic, generally polyvinyl butyral (PVB) between which an array of wires in the form of a uniform grid is placed. For example, the grid consists of a wire fabric bonded, by heating, between the PVB sheets, or etched directly on a transparent substrate, of glass or polyethylene terephthalate (PET), by the usual photolithography technique, and said substrate then being joined to the PVB sheets.

The structure applied against the substrate is either kept at a certain distance from the display panel by peripheral fastening means, or it is bonded directly to the glass by means of an adhesive.

FR-A-2 843 273 proposes an improvement of this type of structure, which consists in incorporating a mineral pigment or an inorganic dye into at least one of the thermoplastic sheets in order to reduce the infrared transmission.

Another improvement of the aforementioned structure uses the infrared reflection properties possessed by metal conductors, especially silver. The improvement consists in depositing, directly on the glass of the front substrate, a transparent thin-film multilayer comprising at least one silver-based layer. Such multilayers are for example described in FR-A-2 859 721, WO 01/81262, FR-A-2 868 961 and EP-A-1 155 816.

So as to give the substrate a better impact strength, the front substrate is generally made of toughened glass. Usually its external face, which in the final arrangement lies facing the viewer, is furthermore coated with an advantageously scratch-resistant antireflection coating.

Although the aforementioned substrates improve the problem of infrared transmission in particular through plasma-type field-emission display panels, it is still desirable to have other solutions available. In particular, display panel manufacturers seek solutions that aim to integrate the desired functions, in particular the ability to absorb infrared radiation, directly into the substrate by means of the glass composition so as to simplify the production, by reducing the number of operations, and to reduce the cost.

One object of the invention is to propose a glass composition which allows a field-emission display panel substrate having a low infrared transmission capable of providing an acceptable transmitted image to be produced, in particular with a high brightness, with a high contrast and without impairing the purity of the colors.

It is another object of the invention to provide glass compositions which allow a substrate to be produced by floating molten glass on a bath of molten metal using the “float” process under conditions close to those for a conventional soda-lime-silica glass.

These objects are achieved according to the invention by a glass composition intended for the manufacture of a substrate for a display panel, especially a field-emission display panel, having an infrared radiation transmission factor measured at 910 nm (T_{IR910}) of 40% or less, an overall light transmission factor under illuminant D₆₅ (TL_{D65}) of greater than 40%, a dominant wavelength (D) that varies from 480 to 570 nm and a purity of 8% or less, these values being measured with a glass thickness of 2.8 mm, said composition comprising the following coloring agents, in percentages by weight:

| | |
|---|---|
| Fe₂O₃ (total iron) | 0.4-2% |
| FeO | 0.1-0.6% |
| CoO | 0-200 ppm |
| Se | 0-30 ppm |
| NiO | 0-1000 ppm |
| CuO | 0-6600 ppm. |

Preferably, the glass composition according to the invention possesses a redox, expressed by the ratio of the ferrous iron (FeO) content to the total iron content expressed as Fe₂O₃, which varies from 0.15 to 0.40, advantageously from 0.20 to 0.35.

Also preferably, the glass composition according to the invention has a dominant wavelength that varies from 485 to 520 nm.

Again preferably, the glass composition according to the invention has a purity of less than 5% and advantageously less than 3%.

According to the invention, the glass composition comprises, in addition to the aforementioned coloring agents, constituents intended to form the glass matrix, said constituents being present in the following proportions by weight:

| | |
|---|---|
| SiO₂ | 53-75% |
| Al₂O₃ | 0-10% |
| ZrO₂ | 0-8% |
| Na₂O | 2-8% |
| K₂O | 0-10% |
| Li₂O | 0-2% |
| CaO | 0-12% |
| MgO | 0-9% |
| SrO | 0-12% |
| BaO | 0-12%. |

Preferably, the glass matrix comprises:

| | |
|---|---|
| SiO₂ | 57-75%, preferably greater than 68% |
| Al₂O₃ | 0-7%, preferably 1-6% |
| ZrO₂ | 2-7%, preferably 2.5-4.5% |
| Na₂O | 2-6%, preferably 3-5% |
| K₂O | 2-10%, preferably 5-9% |
| Li₂O | 0-1%, preferably less than 0.5% |
| CaO | 2-11%, preferably 5-11% |
| MgO | 0-4%, preferably 0-2% |
| SrO | 2-9%, preferably 5-9% |
| BaO | 0-9%, preferably 0-5%. |

According to a first embodiment, the glass composition includes as coloring agents the combination of the compounds below in the following proportions expressed as percentages by weight:

| | |
|---|---|
| Fe₂O₃ (total iron) | 0.5-1.9% |
| FeO | 0.10-0.55% |
| CoO | 20-150 ppm |
| NiO | 0-550 ppm |
| Se | 0-20 ppm. |

Advantageously, the redox varies from 0.25 to 0.35.

This composition makes it possible to obtain a glass characterized in that it has a neutral gray color particularly suitable for the production of a display panel.

The compositions containing only Fe₂O₃ and FeO as coloring agents make it possible to obtain a glass having a high overall light transmission factor TL_{D65}, this usually being greater than 60%.

The introduction of CoO, either by itself or combined with NiO and/or Se, makes it possible for the color of the glass to be better adjusted by varying the dominant wavelength or the purity while preserving a good overall light transmission level under illuminant D₆₅.

According to a second embodiment, the glass compositions comprise as coloring agents the combination of the compounds below in the following proportions expressed in percentages by weight:

| | |
|---|---|
| Fe₂O₃ (total iron) | 0.4-1.8% |
| FeO | 0.10-0.45% |
| CuO | 350-6600 ppm |
| NiO | 0-1000 ppm, |
| | preferably 100-1000 ppm. |

Advantageously, the redox varies from 0.20 to 0.30.

This composition makes it possible to obtain a glass that can be melted satisfactorily, especially in a flame-fired furnace, owing to the low amount of ferrous iron. This makes it possible to achieve good transmission of the radiation emitted by the flame into the glass melt and therefore effective heat transfer.

The compositions containing Fe₂O₃, FeO and CuO as coloring agents result in glasses having a high overall transmission factor TL_{D65} similar to the glasses of the previous embodiment.

The addition of NiO into the composition helps to achieve a better adjustment of the purity of the glass while maintaining a good overall light transmission level under illuminant D₆₅.

The glass compositions according to the invention have in particular the advantage of being able to be melted and converted into glass ribbon under the standard conditions of the float process, at temperatures similar to those used in the manufacture of conventional soda-lime silica glass.

In these compositions, SiO₂ plays an essential role. Within the context of the invention, the content must not exceed 75%; above this, melting of the batch requires a high temperature, and moreover the thermal expansion coefficient of the glass becomes too low. Below 53%, the stability of the glass also the strain point are insufficient.

Al₂O₃ plays a stabilizing role. It allows the strain point of the glass to be increased, and it improves the chemical resistance, especially in a basic medium. The percentage of Al₂O₃ advantageously does not exceed 10%, preferably 7%, and better still 6%, in order to prevent an unacceptably large increase in the viscosity at high temperatures and to prevent an excessive reduction in the thermal expansion coefficient.

ZrO₂ also acts as a stabilizer. It improves the chemical resistance of the glass and helps to increase the strain point. Above 8%, the risk of devitrification increases and the thermal expansion coefficient decreases. Even though this oxide is difficult to melt, it is advantageous as it does not increase the viscosity of the glass at high temperatures to the same extent as SiO₂ and Al₂O₃.

In general, the melting of the glasses according to the invention remains within acceptable limits provided that the sum of the oxides SiO₂, Al₂O₃ and ZrO₂ also remains at or below 75%. The term “acceptable limits” is understood to mean that the temperature of the glass corresponding to a viscosity η of 100 poise does not exceed 1550° C. and preferably 1510° C.

Na₂O and K₂O keep the melting point and the viscosity at high temperatures within the limits given above. They also control the thermal expansion coefficient. The total content of Na₂O and K₂O is generally at least equal to 8%, preferably at least equal to 10%. Above 15%, the strain point becomes too low. As a general rule, the K₂O/Na₂O weight ratio is at least equal to 1, preferably at least equal to 1.2.

It is also possible to incorporate Li₂O into the glass composition as a flux, in a content that may be up to 2%, but preferably does not exceed 1% and advantageously 0.5%. As a general rule, the composition does not contain Li₂O.

The alkaline-earth metal oxides Cao, MgO, SrO and BaO have the effect of reducing the melting point and the viscosity of the glass at high temperatures. They also generally raise the strain point. The total content of these oxides is generally at least equal to 15%. Above 25%, the risk of devitrification becomes incompatible with the float process conditions.

The BaO content, generally less than 12%, is preferably less than 9% and better still less than 5% in order to limit the formation of barium sulfate (BaSO₄) crystals that impair the optical quality of the glass. Preferably, the BaO content in the glass corresponds to the inevitable impurities of the batch materials.

SrO helps to raise the strain point and increases the chemical resistance of the glass. Its content is preferably less than 9%.

The glass composition according to the invention can be melted and converted into glass ribbon by floating the glass on a bath of molten metal under the conditions of the float process for conventional soda-lime silicate glass compositions.

The glass ribbon is then cut to the appropriate dimensions in order to form substrates for display panels, especially as the front face.

The examples that follow illustrate the invention without however limiting it.

Glass compositions comprising the coloring agents in the proportions given in Table 1 were produced.

In these examples, the glass matrix consists of the following constituents, in percentages by weight:

| | |
|---|---|
| SiO₂ | 68.5% |
| Al₂O₃ | 0.7% |
| Na₂O | 4.5% |
| K₂O | 5.5% |
| CaO | 10.0% |
| SrO | 7.0% |
| ZrO₂ | 3.8%. |

Each composition was placed in a platinum crucible and melted at 1500° C. The molten glass was deposited on a carbon table and formed into a sheet. The sheet was annealed in a furnace at 655° C. for 60 minutes. The sheet was cut into specimens measuring 50×50×2.8 mm, which were then polished.

The following parameters were measured on the specimens:
the infrared radiation transmission factor has a wavelength of 910 nm (T_{IR910});
the overall light transmission factor under illuminant D₆₅ (TL_{D65}) integrated between 380 and 780 nm and calculated according to the EN 410 standard;
the dominant wavelength (λ_{D}) under illuminant D₆₅; and
the excitation purity (P_{D65}) under illuminant D₆₅; and
the redox, defined as the ratio of the mass content of ferrous iron (expressed as FeO) to the mass content of total iron (expressed as Fe₂O₃).

The infrared transmission (T_{IR910}), the light transmission (TL_{D65}), the dominant wavelength (λ_{D}) and the purity (P_{D65}) were calculated by taking the 1931 CIE (International Commission on Illumination) reference observer. To determine the redox, the total iron content (Fe₂O₃) was measured by X-ray fluorescence and the ferrous iron (FeO) content was measured by wet chemistry.

The compositions according to the invention make it possible to obtain glass sheets compatible with use as display panel substrates: the infrared transmission factor T_{IR910} is at most equal to 40% and the light transmission factor TL_{D65} is greater than 40%, the dominant wavelength is between 480 and 570 nm and the purity is less than 8%.

The glass compositions combining Fe₂O₃, FeO and optionally CoO, NiO and/or Se (examples 1 to 11) have the advantage of having a particularly advantageous neutral gray color.

Examples 6 and 8 to 11 which combine CoO with NiO and/or Se make it possible to reduce the purity of the glass—and therefore to have a more neutral color compared with Examples 2, 1 and 3 to 5 respectively, and to do so while still maintaining a similar T_{IR910} factor.

Example 7, which contains a higher amount of selenium than Example 8, makes it possible to obtain a glass with a purity similar to that of Example 1 but with a higher dominant wavelength.

The compositions of Examples 12 to 19, which combine Fe₂O₃, FeO and CuO, and optionally NiO, have a relatively neutral gray color.

In Examples 16 to 18, the addition of NiO makes it possible to further reduce the purity of the glasses of Examples 12 to 14, respectively.

These compositions can be melted under particularly favorable thermal conditions. The composition of Example 15 is melted under even more favorable conditions than that in Example 5 thanks to the lower FeO content, for a glass having practically the same properties as the glass of Example 5.

| | Example | | | | | | | | | |
|---|---|---|---|---|---|---|---|---|---|---|
| | 1 | 2 | 3 | 4 | 5 | 6 | 7 | 8 | 9 | 10 |
| Coloring | | | | | | | | | | |
| agents | | | | | | | | | | |
| Fe₂O₃ (total | 0.64 | 0.59 | 0.70 | 1.10 | 1.71 | 0.59 | 0.69 | 0.72 | 0.70 | 1.10 |
| iron) (%) | | | | | | | | | | |
| FeO (%) | 0.19 | 0.16 | 0.21 | 0.32 | 0.51 | 0.15 | 0.19 | 0.20 | 0.21 | 0.32 |
| CoO (ppm) | — | — | — | — | — | 35 | 62 | 64 | 40 | 68 |
| NiO (ppm) | — | — | — | — | — | 60 | — | — | 460 | — |
| Se (ppm) | — | — | — | — | — | 4 | 10 | 7 | — | 20 |
| CuO (ppm) | — | — | — | — | — | — | — | — | — | — |
| Redox | 0.30 | 0.27 | 0.30 | 0.29 | 0.30 | 0.26 | 0.27 | 0.27 | 0.30 | 0.29 |
| Properties | | | | | | | | | | |
| T_{IR910} (%) | 34 | 38 | 29 | 16 | 6 | 39 | 35 | 34 | 27 | 16 |
| TL_{D65} (%) | 80 | 82 | 80 | 74 | 64 | 70 | 60 | 61 | 55 | 51 |
| λ_{D} (nm) | 503 | 497 | 485 | 497 | 501 | 499 | 563 | 503 | 518 | 533 |
| P_{D65} (%) | 1.8 | 2.0 | 2.8 | 4.0 | 5.2 | 1.4 | 2.1 | 1.0 | 1.5 | 1.6 |

| | Example | | | | | | | | |
|---|---|---|---|---|---|---|---|---|---|
| | 11 | 12 | 13 | 14 | 15 | 16 | 17 | 18 | 19 |
| Coloring | | | | | | | | | |
| agents | | | | | | | | | |
| Fe₂O₃ (total | 1.71 | 0.52 | 0.72 | 0.99 | 1.70 | 0.52 | 0.75 | 0.99 | 0.82 |
| iron) (%) | | | | | | | | | |
| FeO (%) | 0.51 | 0.14 | 0.19 | 0.25 | 0.44 | 0.14 | 0.19 | 0.25 | 0.22 |
| CoO (ppm) | 80 | — | — | — | — | — | — | — | — |
| NiO (ppm) | — | — | — | — | — | 220- | 150 | 420 | 900 |
| Se (ppm) | 14 | — | — | — | — | — | — | — | — |
| CuO (ppm) | — | 500 | 1000 | 1200 | 500 | 500 | 400 | 1200 | 4500 |
| Redox | 0.30 | 0.27 | 0.26 | 0.25 | 0.26 | 0.27 | 0.26 | 0.25 | 0.27 |
| Properties | | | | | | | | | |
| T_{IR910} (%) | 6 | 39 | 26 | 18 | 7 | 37 | 29 | 17 | 9 |
| TL_{D65} (%) | 42 | 81 | 76 | 72 | 64 | 71 | 73 | 57 | 42 |
| λ_{D} (nm) | 518 | 492 | 492 | 492 | 500 | 515 | 514 | 513 | 510 |
| P_{D65} (%) | 2.6 | 3.9 | 6.5 | 7.7 | 5.7 | 1.5 | 2.0 | 3.1 | 7.5 |

1. A glass composition intended for the manufacture of a substrate for a display panel, characterized in that it has an infrared radiation transmission factor measured at 910 nm (T_{IR910}) of 40% or less, an overall light transmission factor under illuminant D₆₅ (TL_{D65}) of greater than 40%, a dominant wavelength (λ_{D}) that varies from 480 to 570 nm and a purity of 8% or less, these values being measured with a glass thickness of 2.8 mm, said composition being formed from the following coloring agents, in percentages by weight:
Fe₂O₃ 0.4-2%
FeO 0.1-0.6%
CoO 0-200 ppm
Se 0-30 ppm
NiO 0-1000 ppm
CuO 0-6600 ppm.

2. The composition as claimed in claim 1, characterized in that the redox varies from 0.15 to 0.40.

3. The composition as claimed in claim 1, characterized in that the dominant wavelength varies from 485 to 520 nm.

4. The composition as claimed in claim 1, characterized in that the purity is less than 5%.

5. The composition as claimed in claim 1, characterized in that it comprises constituents intended to form the glass matrix, said constituents being present in the following proportions by weight:
SiO₂ 53-75%
Al₂O₃ 0-10%
ZrO₂ 0-8%
Na₂O 2-8%
K₂O 0-10%
Li₂O 0-2%
CaO 0-12%
MgO 0-9%
SrO 0-12%
BaO 0-12%

6. The composition as claimed in claim 5, characterized in that it comprises:
SiO₂ 57-75%, preferably greater than 68%
Al₂O₃ 0-7%, preferably 1-6%
ZrO₂ 2-7%, preferably 2.5-4.5%
Na₂O 2-6%, preferably 3-5%
K₂O 2-10%, preferably 5-9%
Li₂O 0-1%, preferably less than 0.5%
CaO 2-11%, preferably 5-11%
MgO 0-4%, preferably 0-2%
SrO 2-9%, preferably 5-9%
BaO 0-9%, preferably 0-5%.

7. The composition as claimed in claim 1, characterized in that it includes as coloring agents the compounds below in the following proportions expressed as percentages by weight:
Fe₂O₃ 0.5-1.9%
FeO 0.10-0.55%
CoO 20-150 ppm
NiO 0-550 ppm
Se 0-20 ppm.

8. The composition as claimed in claim 7, characterized in that the redox varies from 0.25 to 0.35.

9. The composition as claimed in claim 1, characterized in that it includes as coloring agents the compounds below in the following proportions expressed in percentages by weight:
Fe₂O₃ 0.4-1.8%
FeO 0.10-0.45%
CuO 350-6600 ppm
NiO 0-1000 ppm.

10. The composition as claimed in claim 9, characterized in that the redox varies from 0.20 to 0.30.

11. The method of using the glass composition as claimed in claim 1 for producing a substrate for a display panel.

12. The method of using as claimed in claim 11, characterized in that the substrate forms the front face of a plasma display panel.

13. A display panel, comprising two glass substrates separated by a space containing a plasma gas mixture, characterized in that at least one of the substrates consists of a glass having the composition as claimed in claim 1.

14. The display panel as claimed in claim 13, characterized in that the substrate forms the front face.
